(19) United States
(12) Patent Application Publication
(10) Pub. No.: US 2026/0088333 A1
(43) Pub. Date: Mar. 26, 2026

(54) APPARATUS AND METHOD FOR MANUFACTURING BATTERY

(71) Applicant: SAMSUNG SDI CO., LTD., Yongin-si (KR)

(72) Inventors: Young Jin JANG, Suwon-si (KR); Jung Hun CHOI, Suwon-si (KR)

(21) Appl. No.: 19/285,443

(22) Filed: Jul. 30, 2025

(30) Foreign Application Priority Data
Sep. 24, 2024 (KR) 10-2024-0129453

(51) Int. Cl. H01M 10/04; B21D 22/10; B21D 37/04

(52) U.S. Cl. CPC H01M 10/0481; B21D 22/10; B21D 37/04

(57) ABSTRACT

A battery manufacturing apparatus and a battery manufacturing method are disclosed. A battery manufacturing apparatus includes a base, a mold including a mold body movably arranged on the base and a shape determination body inserted in the mold body, and an adjuster which is fixed to the base and configured to come into contact with the mold body to move the mold body.

### CROSS-REFERENCE TO RELATED APPLICATION

The present application claims priority to and the benefit of Korean Patent Application No. 10-2024-0129453, filed on Sep. 24, 2024 in the Korean Intellectual Property Office, the entire disclosure of which is incorporated herein by reference.

### BACKGROUND

### 1. Field

Aspects of embodiments of the present disclosure relate to a battery manufacturing apparatus and a battery manufacturing method.

### 2. Discussion of Related Art

Secondary batteries are capable of being charged and discharged, unlike primary batteries that cannot be charged. Low-capacity secondary batteries may be used in small portable electronic devices, such as smartphones, feature phones, notebook computers, digital cameras, and camcorders, and large-capacity secondary batteries are widely used as power sources for driving motors of hybrid vehicles, electric vehicles, and the like, and as batteries for power storage. Such a secondary battery includes an electrode assembly including a positive electrode and a negative electrode, a case for accommodating the electrode assembly, a stack terminal connected to the electrode assembly, and the like.

A case for accommodating an electrode assembly may vary, and a case for accommodating an angular or prismatic battery may be called a can. Cans may be manufactured through various methods. For example, a can with one open side may be manufactured by pressing a slug with a board shape using a punch. When the punch presses the slug through such a method, adjustment of a clearance between a mold into which the slug and the punch are inserted and the punch is very important. This is because whether the can is defective can be determined according to the adjustment of the clearance.

Accordingly, the need for a battery manufacturing apparatus and a battery manufacturing method which may maintain an optimized clearance according to a work environment and product specifications has been increasing.

The above information disclosed in this Background section is provided for enhancement of understanding of the background of the present disclosure, and, therefore, it may contain information that does not constitute related (or prior) art.

### SUMMARY

According to an aspect of embodiments of the present invention, a battery manufacturing apparatus and a battery manufacturing method capable of precisely manufacturing a battery are provided.

According to another aspect of embodiments of the present invention, a battery manufacturing apparatus and a battery manufacturing method capable of adjusting a clearance to minimize or reduce a defect rate of a can are provided.

The above and other aspects and features of the present disclosure will be described in or will be apparent from the following description of some embodiments of the present disclosure.

According to one or more embodiments of the present invention, a battery manufacturing apparatus includes a base, a mold including a mold body movably arranged on the base and a shape determination body inserted in the mold body, and an adjuster which is fixed to the base and configured to come into contact with the mold body to move the mold body.

A slug may be arranged in the mold, and the slug may be inserted in a shape determination hole defined in the shape determination body by a punch to be molded into a can.

The adjuster may include a first direction adjuster on each of two sides of the mold body in a first direction and a second direction adjuster on each of two sides of the mold body in a second direction perpendicular to the first direction.

Each of the first direction adjuster and the second direction adjuster may include an adjustment fixing body fixed to the base part and an adjustment contact body which comes into contact with the mold body to adjust a distance between the adjustment fixing body and the mold body.

Each of the first direction adjuster and the second direction adjuster may include an adjustment wedge block provided in a wedge shape which protrudes from the adjustment fixing body and of which a width decreases away from the mold body, and each of the first direction adjuster and the second direction adjuster further may include an adjustment wedge hole which is formed in the adjustment wedge block and in which the adjustment contact body is inserted.

Each of the first direction adjuster and the second direction adjuster may further include an adjustment support body located between the adjustment fixing body and the mold body to come into contact with the adjustment fixing body and the mold body.

The battery manufacturing apparatus may further include a measurer which is fixed to the base part and is in contact with the mold body to measure a movement amount of the mold body.

The measurer may include a first direction measurer on a side surface of the mold body in the first direction, and a second direction measurer on a side surface of the mold body in the second direction.

Each of the first direction measurer and the second direction measurer may include a measurement body fixed to the base part, a measurement contact portion which protrudes from the measurement body and is in contact with the mold body, and a measurement gauge configured to display a distance between the measurement body and the measurement contact portion.

The first direction measurer and the second direction measurer may be provided as a plurality of first direction measurers and a plurality of second direction measurers.

The adjuster may be between the plurality of first direction measurers or between the plurality of second direction measurers.

The mold may include a mold body recess provided as a groove formed in the mold body to be concave inward, and the adjuster may be inserted in the mold body recess.

The mold body recess may include mold body adjustment surfaces facing each other, and a mold body contact surface connecting the mold body adjustment surfaces.

The adjuster may include an adjustment fixing body fixed to the base, an adjustment wedge block protruding from the adjustment fixing body, an adjustment contact body which passes through the adjustment wedge block and comes into contact with the mold body adjustment surface, and an adjustment support body which comes into contact with the adjustment wedge block and the mold body contact surface.

According to one or more embodiments of the present invention, a battery manufacturing method includes a first direction adjustment including moving a mold with respect to a base using a first direction adjuster, a first direction adjustment release including releasing fixation of the first direction adjuster, and a second direction adjustment including moving the mold with respect to the base using a second direction adjuster.

The battery manufacturing method may further include an adjuster fixing including fixing the first direction adjuster and the second direction adjuster after the second direction adjustment.

In the first direction adjustment, the mold part may be rotated with respect to the base.

In the first direction adjustment, a position of the mold may be measured by a first direction measurer in contact with the mold.

In the second direction adjustment, a position of the mold part may be measured by a second direction measurer in contact with the mold.

### BRIEF DESCRIPTION OF THE DRAWINGS

The drawings provided with this specification illustrate some embodiments of the present disclosure, and further describe aspects and features of the present disclosure together with the detailed description of the present disclosure. However, the present disclosure should not be construed as being limited to the drawings.

FIG. 1 is a perspective view illustrating a battery manufacturing apparatus according to an embodiment of the present invention;

FIG. 2 is an exploded perspective view illustrating the battery manufacturing apparatus according to an embodiment of the present invention;

FIG. 3 is a plan view illustrating the battery manufacturing apparatus according to an embodiment of the present invention;

FIG. 4 is a schematic view illustrating a process of operating the battery manufacturing apparatus according to an embodiment of the present invention;

FIG. 5 is a perspective view illustrating an adjustment part and a measurement part according to an embodiment of the present invention;

FIG. 6 is a plan view illustrating the adjustment part according to an embodiment of the present invention;

FIG. 7 is a flowchart illustrating a battery manufacturing method according to an embodiment of the present invention;

FIG. 8 is a schematic view illustrating an operation of moving a mold part using a first direction adjustment part according to an embodiment of the present invention;

FIG. 9 is a schematic view illustrating an operation of moving the mold part using a second direction adjustment part according to an embodiment of the present invention;

FIG. 10 is a schematic view illustrating an operation of fixing the mold part to a base part according to an embodiment of the present invention;

FIG. 11 is a schematic view illustrating an operation of rotating and moving the mold part according to an embodiment of the present invention;

FIG. 12 is a schematic view illustrating an operation of moving the mold part using the first direction adjustment part according to an embodiment of the present invention; and

FIG. 13 is a schematic view illustrating an operation of moving the mold part using the second direction adjustment part according to an embodiment of the present invention.

### DETAILED DESCRIPTION

Herein, some embodiments of the present disclosure will be described in further detail with reference to the accompanying drawings. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to one or more embodiments of the present disclosure. Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element or feature as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented, e.g., rotated 90 degrees or at other orientations, and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between and including the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed or located or positioned on the “above or below” or “on or under” a component, it may mean that the arbitrary element is placed in contact with the upper or lower surface of the component and may also mean that another component may be interposed between the component and any arbitrary element disposed or located or positioned on or under the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part, or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

In the present invention, a first direction is not limited to an X-axis direction, a second direction is not limited to a Y-axis direction, the first direction may be set as the Y-axis direction, and the second direction may be set as the X-axis direction.

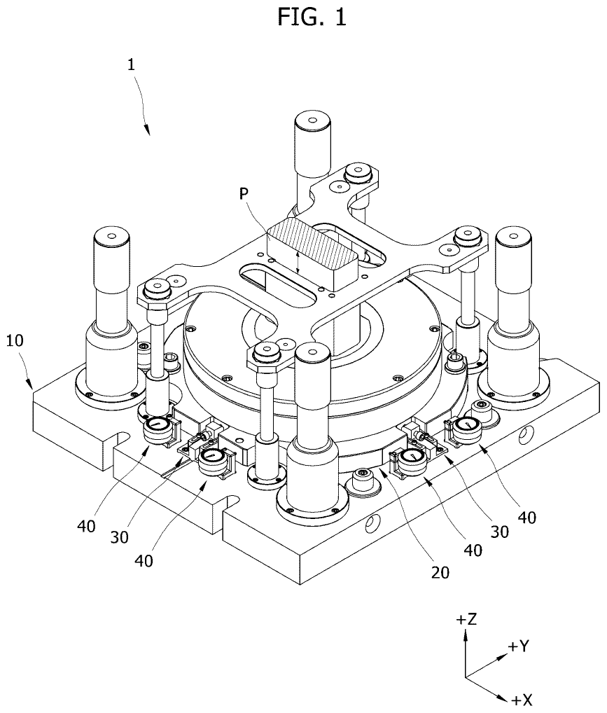

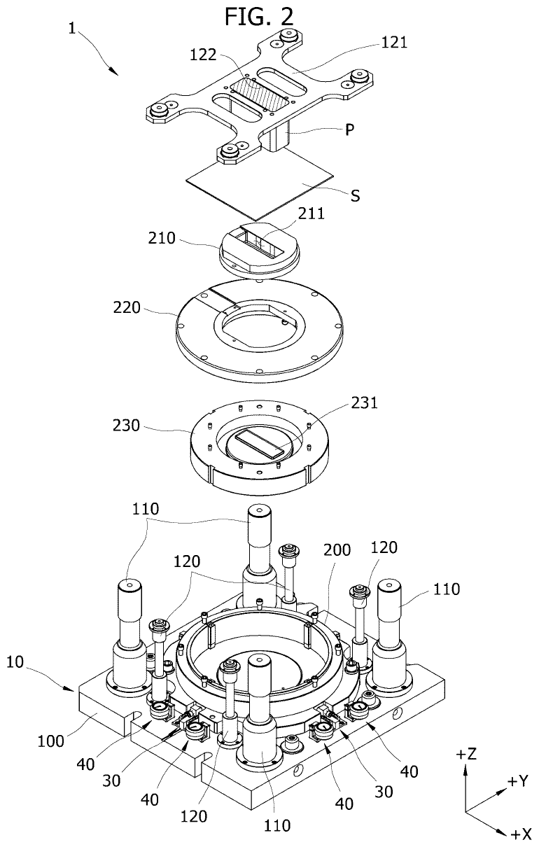

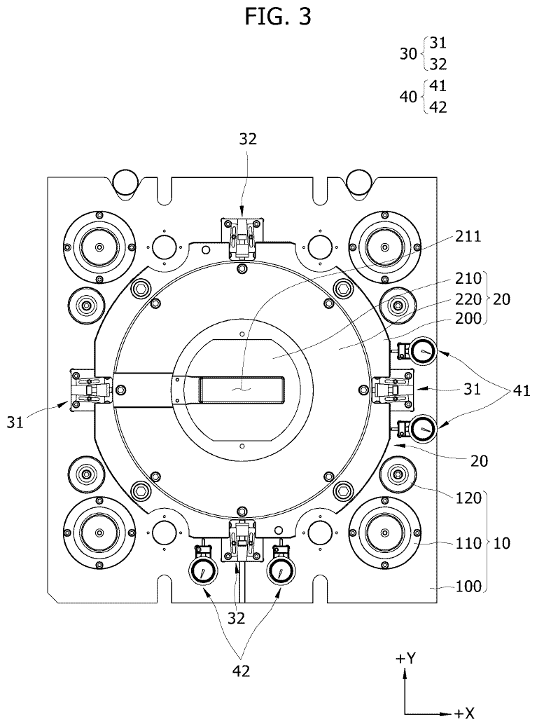

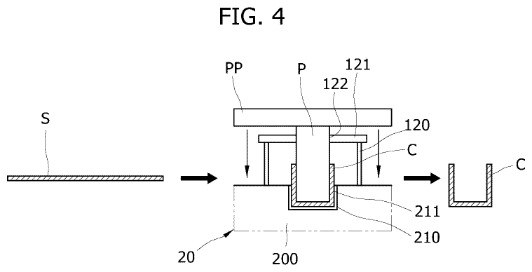

FIG. 1 is a perspective view illustrating a battery manufacturing apparatus according to an embodiment of the present invention; and FIG. 2 is an exploded perspective view illustrating the battery manufacturing apparatus according to an embodiment of the present invention. FIG. 3 is a plan view illustrating the battery manufacturing apparatus according to an embodiment of the present invention; and FIG. 4 is a schematic view illustrating a process of operating the battery manufacturing apparatus according to an embodiment of the present invention.

A battery manufacturing apparatus 1 is shown in FIGS. 1 to 4. Herein, the battery manufacturing apparatus 1 will be schematically described.

The battery manufacturing apparatus 1 may include a base part, or base, 10, a mold part, or mold, 20, an adjustment part, or adjuster, 30, and a measurement part, or measurer, 40.

The base part 10 may be fixed at a location (e.g., a predetermined location), and the mold part 20, the adjustment part 30, and the measurement part 40 may be disposed on the base part 10.

The mold part 20 may be disposed and moved on the base part 10. According to an embodiment, the mold part 20 may be disposed on the base part 10, moved in a first direction (for example, an X-axis direction) and a second direction (for example, a Y-axis direction) perpendicular to the first direction, and rotated with respect to the base part 10.

The adjustment part 30 may be fixedly disposed on the base part 10, adjust a position of the mold part 20, and fix the position of the mold part 20.

According to an embodiment, the adjustment part 30 may include a first direction adjustment part, or first direction adjuster, 31 and a second direction adjustment part, or second direction adjuster, 32. The first direction adjustment part 31 may be disposed on two side surfaces of the mold part 20 in a direction parallel to the first direction (for example, the X-axis direction) of the mold part 20 and control the mold part 20 to move in the first direction.

The second direction adjustment part 32 may be disposed on two side surfaces of the mold part 20 in a direction parallel to the second direction (for example, the Y-axis direction) of the mold part 20, and adjust the mold part 20 to move in the second direction.

The adjustment part 30 may be controlled in units of a micrometer to precisely adjust the position of the mold part 20 which moves with respect to the base part 10. The adjustment part 30 may rotate and move the mold part 20 with respect to the base part 10.

The measurement part 40 may be fixedly disposed on the base part 10 and measure the position or a movement amount of the mold part 20. The measurement part 40 may measure the position or the movement amount of the mold part 20 in units of a micrometer.

According to an embodiment, the measurement part 40 may include a first direction measurement part, or first direction measurer, 41 and a second direction measurement part, or second direction measurer, 42. The first direction measurement part 41 may be disposed on a side surface of the mold part 20 in the first direction (for example, the X-axis direction), and the second direction measurement part 42 may be disposed on a side surface of the mold part 20 in the second direction (for example, the Y-axis direction).

As the mold part 20 is precisely moved with respect to the base part 10 by the adjustment part 30 and the measurement part 40 as described above, a clearance between the mold part 20 and a punch P may be precisely adjusted. As the clearance is precisely adjusted, the precision of a can C manufactured by the battery manufacturing apparatus 1 can be improved.

Herein, a further detailed structure of the battery manufacturing apparatus 1 will be described.

The base part 10 may include a base body 100, a base guide 110, and a punch guide 120.

In an embodiment, the base body 100 may be provided in a substantially hexahedral shape. The base guide 110 and the punch guide 120 may be disposed on (for example, in a +Z-axis direction of) the base body 100.

The base guide 110 may be connected to a punch press (for example, a punch press PP of FIG. 4) and guide a movement direction of the punch press PP. According to an embodiment, the base guide 110 may guide the punch press PP such that the punch press PP moves in a direction (for example, a Z-axis direction).

The punch guide 120 may be connected to the punch (for example, the punch P of FIG. 4) moved by the punch press PP and guide a movement direction of the punch P. According to an embodiment, the punch guide 120 may guide the punch P such that the punch P moves in a direction (for example, the Z-axis direction).

The punch guide 120 may be connected to a punch guide plate 121. The punch guide plate 121 may be connected to the punch guide 120 and moved in a direction (for example, the Z-axis direction). A punch guide hole 122 passing through the punch guide plate 121 may be provided. A shape of the punch guide hole 122 may correspond to a cross-sectional shape of the punch P. Accordingly, the punch P may be disposed to be inserted into the punch guide hole 122.

A slug S molded into the can C by the battery manufacturing apparatus 1 may be disposed under (for example, in a −Z-axis direction of) the punch P. The punch P may transmit an impact downward (for example, in the −Z-axis direction) to the slug S, and the slug S may be inserted into the mold part 20 by the punch P and molded into the can C.

The mold part 20 may include a mold body 200, a shape determination body 210, a shape fixing body 220, and a punch stopper 230.

The mold body 200 may be disposed on (for example, in the +Z-axis direction of) the base body 100. The mold body 200 may be disposed on the base body 100 and moved on an upper surface of the base body 100. According to an embodiment, the mold body 200 may move on the upper surface of the base body 100 in a direction perpendicular to a direction (for example, the Z-axis direction). The mold body 200 may rotate on the upper surface of the base body 100.

A side (for example, in a +Z-axis direction) of the mold body 200 may be open. The shape determination body 210, the shape fixing body 220, and the punch stopper 230 may be disposed in an open portion of the mold body 200. According to an embodiment, the punch stopper 230 and the shape fixing body 220 may be sequentially disposed on (for example, in the +Z-axis direction of) the mold body 200.

A slug contact portion 231 provided as a flat surface (for example, a flat surface perpendicular to a Z-axis) may be provided on the punch stopper 230. The slug contact portion 231 may come into contact with the slug S to limit movement of the punch P.

An opening may be formed in the shape fixing body 220, and the shape determination body 210 may be disposed in the opening formed in the shape fixing body 220. A shape determination hole 211 provided as a hole passing through the shape determination body 210 may be disposed.

A shape of the shape determination hole 211 may be similar to a shape of the can C and/or the punch P. The punch P may transmit the impact to the slug S, and the punch P and the slug S may be inserted into the shape determination hole 211. As the punch P is inserted into the shape determination hole 211, the slug S molded into the can C may be disposed between the shape determination hole 211 and the punch P.

A thickness of the can C molded from the slug S may be adjusted by a clearance generated between the shape determination hole 211 and the punch P. If the clearance is too large, a shape of the slug S may not be molded, and if the clearance is too small, the slug S may be cut, or the can C molded from the slug S may be defective. If the punch P and the shape determination hole 211 are not properly arranged (for example, are rotated about the Z-axis), the battery manufacturing apparatus 1 may be broken.

Therefore, according to embodiments, a clearance generated between the punch P and the mold part 20 is adjusted by adjusting a position of the mold part 20 which moves with respect to the base part 10.

The adjustment part 30 may be fixed to the base part 10 and move the mold part 20 with respect to the base part 10. The adjustment part 30 may precisely move the mold part 20 with respect to the base part 10. According to an embodiment, the adjustment part 30 may be controlled in units of a micrometer. Accordingly, the adjustment part 30 may precisely move the mold part 20 to precisely adjust a clearance.

The adjustment part 30 may include the first direction adjustment part 31 and the second direction adjustment part 32.

The first direction adjustment part 31 and the second direction adjustment part 32 may be disposed on the side surfaces of the mold part 20. According to an embodiment, the first direction adjustment part 31 may be disposed on the side surface of the mold part 20 in the first direction (for example, the X-axis direction), and the second direction adjustment part 32 may be disposed on the side surface of the mold part 20 in the second direction (for example, the Y-axis direction).

The first direction adjustment part 31 may move the mold part 20 with respect to the base part 10 in the first direction (for example, the X-axis direction), and the second direction adjustment part 32 may move the mold part 20 with respect to the base part 10 in the second direction (for example, the Y-axis direction).

In an embodiment, the first direction adjustment part 31 and the second direction adjustment part 32 may be provided as a plurality of first direction adjustment parts 31 and a plurality of second direction adjustment parts 32, respectively. According to an embodiment, the first direction adjustment parts 31 may be provided at a left side (for example, in a −X-axis direction) and a right side (for example, in a +X-axis direction) of the mold part 20, and the second direction adjustment parts 32 may be provided at a front side (for example, in a +Y-axis direction) and a rear side (for example, in a −Y-axis direction) of the mold part 20.

As the first direction adjustment parts 31 and the second direction adjustment parts 32 are disposed at front, rear, left, and right sides of the mold part 20, the mold part 20 may be moved forward, rearward, leftward, and rightward with respect to the base part 10 and rotated (for example, rotated about a direction parallel to the Z-axis direction) with respect to the base part 10 by the adjustment part 30.

As the adjustment part 30 rotates and moves the mold part 20 as described above, a clearance between the punch P and the mold part 20 may be precisely adjusted.

The measurement part 40 may be fixed to the base part 10 and measure a position and a movement amount of the mold part 20 which moves with respect to the base part 10. The measurement part 40 may precisely move the mold part 20 which moves with respect to the base part 10. According to an embodiment, the measurement part 40 may be controlled in units of a micrometer. Accordingly, the measurement part 40 may precisely measure the position and the movement amount of the mold part 20 and precisely adjust the clearance.

The measurement part 40 may include the first direction measurement part 41 and the second direction measurement part 42.

The first direction measurement part 41 and the second direction measurement part 42 may be disposed on the side surfaces of the mold part 20. According to an embodiment, the first direction measurement part 41 may be disposed on the side surface of the mold part 20 in the first direction (for example, the X-axis direction), and the second direction measurement part 42 may be disposed on the side surface of the mold part 20 in the second direction (for example, the Y-axis direction).

The first direction measurement part 41 may measure a position and a movement amount of the mold part 20 which moves with respect to the base part 10, and the second direction measurement part 42 may measure a position and a movement amount of the mold part 20 which moves with respect to the base part 10 in the second direction.

In an embodiment, the first direction measurement part 41 and the second direction measurement part 42 may be provided as a plurality of first direction measurement parts 41 and a plurality of second direction measurement parts 42, respectively. According to an embodiment, the plurality of first direction measurement parts 41 may be provided at a right side (for example, in the +X-axis direction) of the mold part 20. The plurality of second direction measurement parts 42 may be provided at a rear side (for example, in the −Y-axis direction) of the mold part 20.

As the first direction measurement part 41 and the second direction measurement part 42 are provided as the plurality of first direction measurement parts 41 and the plurality of second direction measurement parts 42, an error of the measurement part 40 for measuring the position and the movement amount of the mold part 20 which moves with respect to the base part 10 may be reduced.

In addition, as the plurality of first direction measurement parts 41 and the plurality of second direction measurement parts 42 are provided, a rotation angle of the mold part 20 with respect to the first direction and/or a rotation angle of the mold part with respect to the second direction may be measured.

As the measurement part 40 measures rotation (an angle) and a movement amount of the mold part 20 as described above, a clearance between the punch P and the mold part 20 may be precisely adjusted.

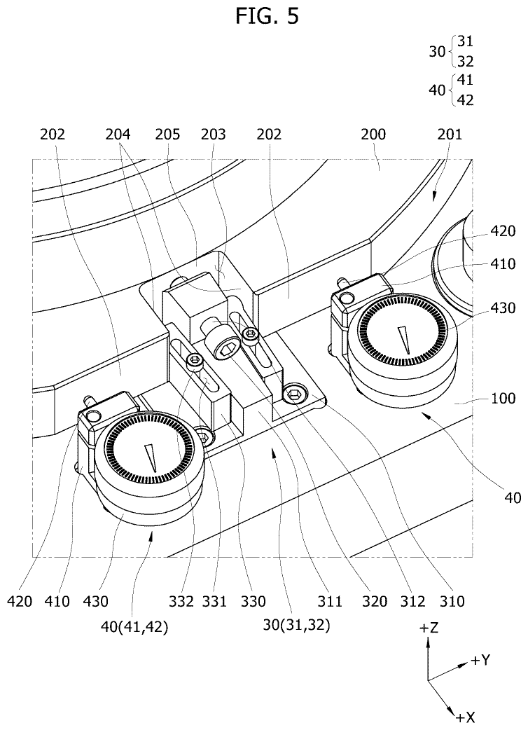

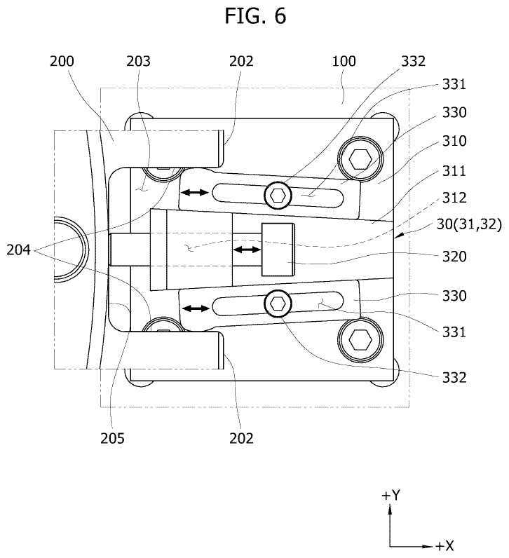

FIG. 5 is a perspective view illustrating an adjustment part and a measurement part according to an embodiment of the present invention; and FIG. 6 is a plan view illustrating the adjustment part according to an embodiment of the present invention.

A base body 100, a mold part 20, a mold body 200, an adjustment part 30, and a measurement part 40 which are illustrated in FIGS. 5 and 6 may be the same as the base body 100, the mold part 20, the mold body 200, the adjustment part 30, and the measurement part 40 which are illustrated in FIGS. 1 to 3. Accordingly, description of the same components may be omitted.

Further detailed structures of the mold part 20, the adjustment part 30, and the measurement part 40 will be described with reference to FIGS. 5 and 6. The description of the adjustment part 30 may replace the descriptions of a first direction adjustment part 31 and/or a second direction adjustment part 32, and the description of the measurement part 40 may replace the descriptions of a first direction measurement part 41 and/or a second direction measurement part 42.

The mold body 200 may be disposed on (for example, in a +Z-axis direction of) the base body 100 and moved and/or rotated with respect to the base body 100. A side surface (for example, a mold body side surface 201) may be formed on the mold body 200. In an embodiment, the mold body side surface 201 may be provided in a substantially circular shape.

A linear mold body portion 202 may be disposed in the mold body side surface 201. The linear mold body portion 202 may be provided as a surface parallel (parallel or substantially parallel) to a direction. According to an embodiment, the linear mold body portion 202 may be provided as the surface parallel to a first direction (for example, an X-axis direction) and/or a second direction (for example, a −Y-axis direction). The linear mold body portion 202 may intersect the first direction and/or to the second direction as the mold body 200 moves with respect to a base part 10. In an embodiment, an angle at which the mold body 200 rotates with respect to the base part may be less than about 10 degrees.

Accordingly, although the mold body 200 rotates with respect to the base part 10, herein, the linear mold body portion 202 may be described as being substantially parallel to the first direction and/or the second direction.

The linear mold body portion 202 may be disposed on front, rear, left, and right sides of the mold body 200. The linear mold body portion 202 may be in contact with the measurement part 40. As the linear mold body portion 202 is provided as the surface parallel to the first direction and/or the second direction, the measurement part in contact with the linear mold body portion 202 may precisely measure a position, a movement amount and/or a rotation (angle) of the mold part 20.

A mold body recess 203 may be disposed adjacent to the linear mold body portion 202. The mold body recess 203 may be provided as a groove concavely formed from the mold body side surface 201 toward a center of the mold body 200. According to an embodiment, the mold body recess 203 may be disposed in the middle of the linear mold body portion 202. However, the mold body recess 203 being disposed in the middle of the linear mold body portion 202 is only one of various embodiments of the present invention, and the mold body recess 203 may be disposed at any of various suitable locations.

In an embodiment, an inner surface of the mold body recess 203 may include mold body contact surfaces 204 extending from the linear mold body portion 202 and facing each other, and a mold body adjustment surface 205 connecting the facing mold body contact surfaces 204.

The mold body contact surfaces 204 and/or the mold body adjustment surface 205 may be disposed parallel to the first direction and/or the second direction. The adjustment part 30 may be disposed in the mold body recess 203. According to an embodiment, the adjustment part 30 may be disposed to be inserted into the mold body recess 203. Accordingly, the mold body contact surfaces 204 and/or the mold body adjustment surface 205 may come into contact with the adjustment part 30.

The adjustment part 30 may be disposed on the base part 10 to come into contact with the mold body 200. According to an embodiment, the adjustment part 30 may be disposed to be inserted into the mold body recess 203. The adjustment part may be disposed to be inserted into the mold body recess 203 and come into contact with the mold body contact surfaces 204 and/or the mold body adjustment surface 205. The adjustment part 30 may come into contact with the mold body contact surfaces 204 and/or the mold body adjustment surface 205 and move the mold part 20 with respect to the base part 10 or restrict the movement. Accordingly, a proper clearance between the mold part 20 and a punch P may be maintained.

In an embodiment, the adjustment part 30 may include an adjustment fixing body 310, an adjustment wedge block 311, an adjustment wedge hole 312, an adjustment contact body 320, an adjustment support body 330, an adjustment support hole 331, and an adjustment support hole insertion member 332.

The adjustment fixing body 310 may be formed in a generally plate shape and fixed to the base body 100. The adjustment wedge block 311 may be disposed on (for example, in a +Z-axis direction of) the adjustment fixing body 310. The adjustment fixing body 310 and the adjustment wedge block 311 may be provided as separate parts or an integrated part.

The adjustment wedge block 311 may be fixed to the adjustment fixing body 310 and formed in a wedge shape with a width decreasing away from a shape determination body 210 disposed in the mold body 200.

The adjustment part 30 may include the adjustment wedge hole 312 provided as a hole passing through the adjustment wedge block 311. The adjustment contact body 320 may be disposed in the adjustment wedge hole 312. According to an embodiment, the adjustment contact body 320 may be disposed to pass through the adjustment wedge hole 312. The adjustment contact body 320 may pass through the adjustment wedge hole 312 and come into contact with the mold body 200. According to an embodiment, the adjustment contact body 320 may come into contact with the mold body adjustment surface 205.

In an embodiment, threads may be formed on the adjustment contact body 320 and the adjustment wedge hole 312, and the adjustment contact body 320 may be engaged with the adjustment wedge hole 312. Accordingly, the adjustment contact body 320 may move in a direction (for example, the X-axis direction) and/or another direction (for example, a Y-axis direction) while rotating with respect the adjustment wedge hole 312.

In an embodiment, the adjustment support body 330 may be provided in a rod shape. The adjustment support body 330 may be disposed on a side surface of the adjustment wedge block 311. According to an embodiment, a plurality of adjustment support bodies 330 may be disposed on both, or opposite, side surfaces of the adjustment wedge block 311. In an embodiment, the adjustment wedge block 311 is formed as the wedge shape, and the adjustment support bodies 330 in contact with the side surfaces of the adjustment wedge block 311 may be disposed to intersect a direction (for example, the X-axis direction) and/or another direction (for example, the Y-axis direction).

The adjustment support bodies 330 may be disposed on the side surfaces of the adjustment wedge block 311 and moved along the adjustment wedge block 311. As the adjustment support bodies 330 move along the adjustment wedge block 311, positions of end portions of the adjustment support bodies 330 may move in a direction or another direction. According to an embodiment, as the adjustment support bodies 330 disposed in the first direction adjustment part 31 move in a +X-axis direction, the end portions of the adjustment support bodies 330 may move in a +Y-axis direction or a −Y-axis direction. As the adjustment support bodies 330 disposed in the second direction adjustment part 32 move in the +Y-axis direction, the end portions of the adjustment support bodies 330 may move in the +X-axis direction or a −X-axis direction. The adjustment support bodies 330 may come into contact with the mold body contact surfaces 204.

In an embodiment, the adjustment support hole 331 may be provided as a hole passing through the adjustment support body 330. The adjustment support hole 331 may be provided as a long hole passing through the adjustment support body 330. The adjustment support hole insertion member 332 may be inserted into the adjustment support hole 331. The adjustment support hole insertion member 332 may be inserted into the adjustment support hole 331 and fixed to the adjustment fixing body 310. In an embodiment, the adjustment support hole insertion member 332 may be provided as a screw and fixed to the adjustment fixing body 310. In an embodiment, the adjustment support hole insertion member 332 is provided as the screw, and a length of the adjustment support hole insertion member 332 protruding from the adjustment fixing body 310 may be adjusted.

As the length of the adjustment support hole insertion member 332 protruding from the adjustment fixing body 310 decreases, the adjustment support hole insertion member 332 may fix the adjustment support body 330, and the adjustment support body 330 may be fixed by the adjustment support hole insertion member 332.

As the length of the adjustment support hole insertion member 332 protruding from the adjustment fixing body 310 increases, the adjustment support hole insertion member 332 may not fix the adjustment support body 330. Accordingly, the adjustment support body 330 may be moved without being fixed to the adjustment fixing body 310. As the adjustment support body 330 moves along the side surface of the adjustment wedge block 311 as described above, the adjustment support body 330 may move from a state in which the adjustment contact body 320 is fixed and come into contact with the mold body contact surface 204, or be spaced apart from the mold body contact surface 204.

When the adjustment contact body 320 moves toward a center of the mold part 20 in a state in which the adjustment support body 330 is in contact with the mold body contact surface 204, the mold body 200 may be moved due to the movement of the adjustment contact body 320.

In a state in which the adjustment contact body 320 is in contact with the mold body adjustment surface 205, the adjustment support body 330 may be spaced apart from the mold body contact surface 204. As the mold body 200 is spaced apart from the adjustment support body 330, the mold body 200 may move.

Referring to FIG. 6, when the plurality of adjustment support bodies 330 move in the +X-axis direction in the state in which the adjustment contact body 320 of the first direction adjustment part 31 is in contact with the mold body adjustment surface 205, the adjustment support bodies 330 may be spaced apart from the mold body contact surfaces 204. As the adjustment support bodies 330 are spaced apart from the mold body contact surfaces 204, the mold body 200 may move in the Y-axis direction. As the mold body 200 moves in the Y-axis direction as described above, the mold body 200 may rotate clockwise or counterclockwise.

Referring to FIG. 6, when the adjustment contact body 320 moves in a −X-axis direction in a state in which the plurality of adjustment support bodies 330 are in contact with the mold body contact surfaces 204, the adjustment contact body 320 may come into contact with the mold body adjustment surfaces 205 and move the mold body 200 in the −X-axis direction.

As the mold body 200 is moved or rotated by the first direction adjustment part 31 and the second direction adjustment part 32 as described above, a clearance between the mold part 20 and the punch P may be precisely adjusted.

In an embodiment, the measurement part 40 may include a measurement body 410, a measurement contact portion 420, and a measurement gauge 430.

The measurement body 410 may be fixed to the base body 100. In an embodiment, the measurement contact portion 420 may be provided as a pin or rod protruding from the measurement body 410. The measurement contact portion 420 may be in contact with the mold body 200. A length of the measurement contact portion 420 protruding from the measurement body 410 may change. As the length of the measurement contact portion 420 in contact with the mold body 200 and protruding from the measurement body 410 changes, a position or a movement amount of the mold body 200 with respect to the base part 10 may be measured. The measurement gauge 430 may display the protruding length of the measurement contact portion 420. The measurement gauge 430 may display in units of a micrometer.

In an embodiment, the measurement part 40 may be provided as a plurality of measurement parts 40. In an embodiment, the measurement parts 40 may be disposed at front, rear, left, and right sides of the mold part 20. The plurality of measurement parts 40 may be provided at respective sides of the mold part 20. As the plurality of measurement parts 40 are provided at respective sides of the mold part 20, a position, a movement amount, and a rotation angle of the mold body 200 may be measured.

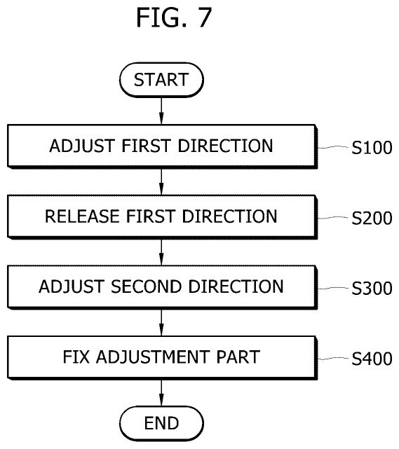

FIG. 7 is a flowchart illustrating a battery manufacturing method according to an embodiment of the present invention.

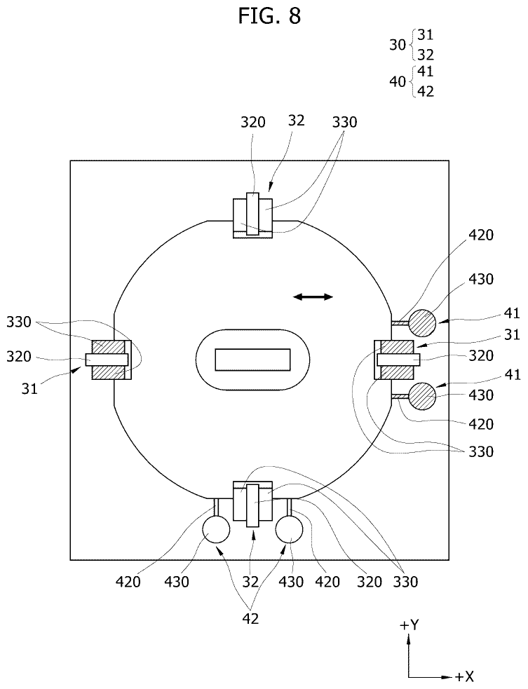

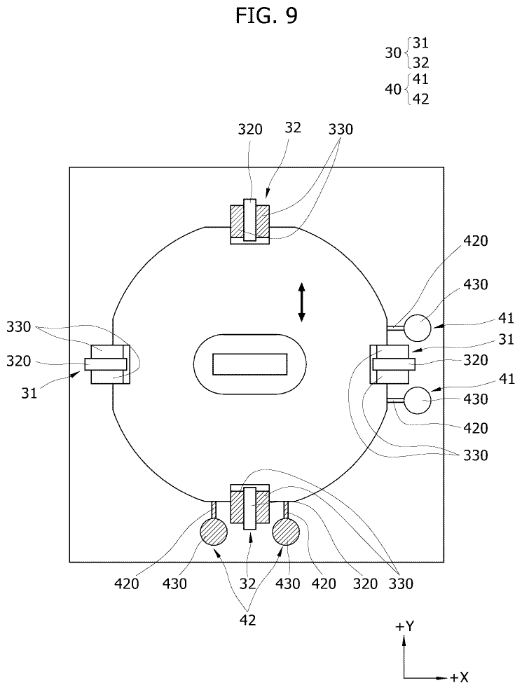

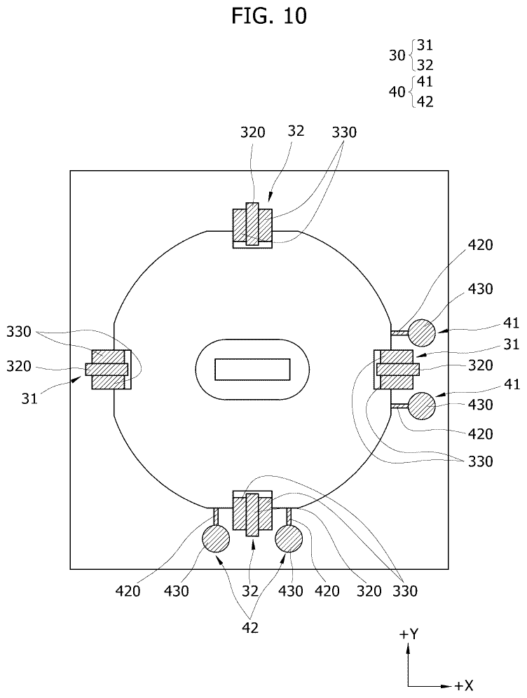

FIG. 8 is a schematic view illustrating an operation of moving a mold part using a first direction adjustment part according to an embodiment of the present invention; FIG. 9 is a schematic view illustrating an operation of moving the mold part using a second direction adjustment part according to an embodiment of the present invention; and FIG. 10 is a schematic view illustrating an operation of fixing the mold part to a base part according to an embodiment of the present invention.

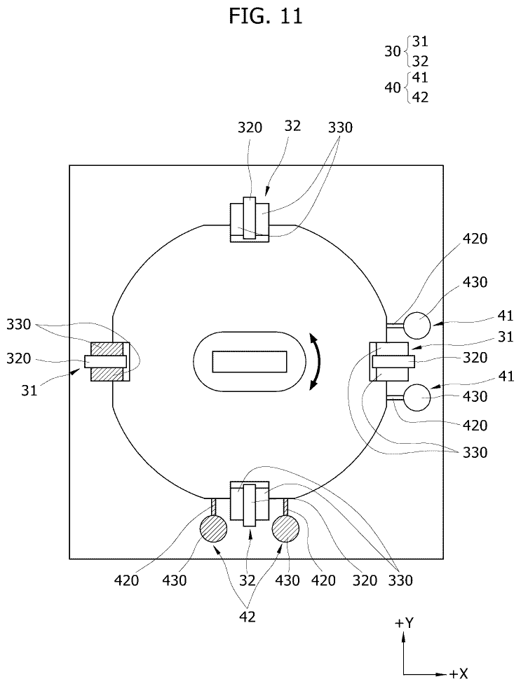

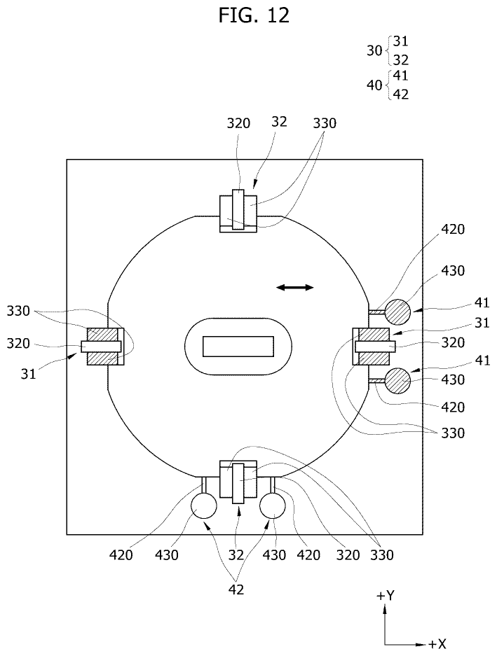

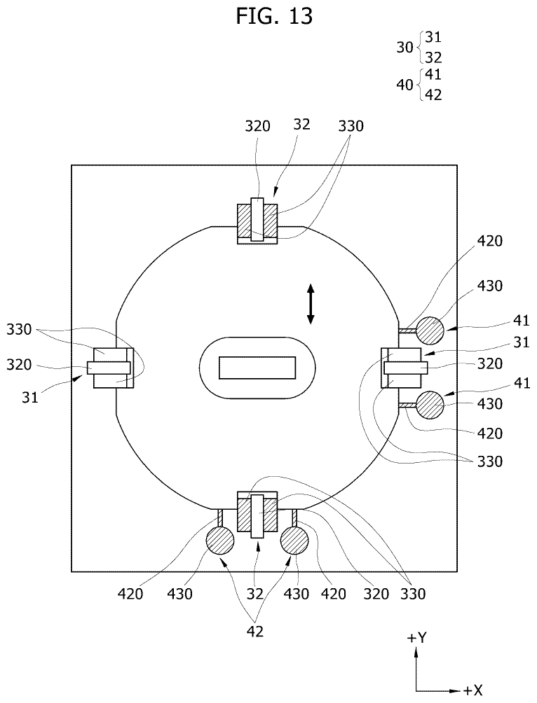

FIG. 11 is a schematic view illustrating an operation of rotating and moving the mold part according to an embodiment of the present invention; FIG. 12 is a schematic view illustrating an operation of moving the mold part using the first direction adjustment part according to an embodiment of the present invention; and FIG. 13 is a schematic view illustrating an operation of moving the mold part using the second direction adjustment part according to an embodiment of the present invention.

The battery manufacturing method will be described with reference to FIG. 7. A process in which the mold part moves linearly will be described with reference to FIGS. 8 to 10, and a process in which the mold part rotates and moves will be described with reference to FIGS. 11 to 13.

Referring to FIGS. 7 to 13, the battery manufacturing method may include a first direction adjustment operation S100 (see FIG. 7) of moving a mold part, or mold, with respect to a base part, or base, 10 using a first direction adjustment part, or first direction adjuster, 31; a first direction adjustment release operation S200 (see FIG. 7) of releasing fixation of the first direction adjustment part 31; a second direction adjustment operation S300 (see FIG. 7) of moving the mold part 20 with respect to the base part 10 using a second direction adjustment part, or second direction adjuster, 32; and an adjustment part fixing operation S400 (see FIG. 7) of fixing the first direction adjustment part 31 and the second direction adjustment part 32.

The first direction adjustment operation S100 (see FIG. 7) of moving the mold part 20 with respect to the base part 10 using the first direction adjustment part 31 will be described with reference to FIGS. 7 to 10. Referring to FIG. 8, an adjustment support body 330 of the first direction adjustment part 31 may be fixed to an adjustment fixing body 310 while in contact with a mold body 200. According to an embodiment, the adjustment support body 330 may be fixed to the adjustment fixing body 310 while in contact with a mold body contact surface 204. When the adjustment support body 330 of the first direction adjustment part 31 is fixed to the adjustment fixing body 310, movement of the mold body 200 may be restricted in a second direction (for example, a Y-axis direction). In a state in which the movement of the mold body 200 in the second direction is restricted, if the adjustment contact body 320 of the first direction adjustment part 31 is controlled to come into contact with the mold body 200, the mold body 200 may move in a first direction (for example, an X-axis direction). According to an embodiment, the adjustment contact body 320 of the first direction adjustment part 31 may come into contact with the mold body adjustment surface 205 to move the mold body 200 in the first direction.

The first direction adjustment release operation S200 (see FIG. 7) of releasing fixation of the first direction adjustment part 31 will be described. A position of the mold part 20 may be measured by a first direction measurement part 41 which comes into contact with the mold part 20. When a position of the mold body 200 with respect to the base part 10 in the first direction (for example, the X-axis direction) is set by the first direction adjustment part 31, the position, a movement amount, and/or a rotation angle of the mold body 200 may be confirmed using a value measured by a first direction measurement part 41 of a measurement part 40. The adjustment contact body 320 and the adjustment support body 330 of the first direction adjustment part 31 may be spaced apart from the mold body contact surface 204 and/or the mold body adjustment surface 205. Accordingly, the fixation of the first direction adjustment part 31 may be released such that the mold body 200 may move.

The second direction adjustment operation S300 (see FIG. 7) of moving the mold part 20 with respect to the base part 10 using the second direction adjustment part 32 will be described. Referring to FIG. 9, the adjustment support body 330 of the second direction adjustment part 32 may be fixed to the adjustment fixing body 310 while in contact with the mold body 200. According to an embodiment, the adjustment support body 330 may be fixed to the adjustment fixing body 310 while in contact with the mold body contact surface 204. When the adjustment support body 330 of the second direction adjustment part 32 is fixed to the adjustment fixing body 310, the movement of the mold body 200 in the first direction (for example, the X-axis direction) may be restricted. In a state in which the movement of the mold body 200 in the first direction is restricted, if the adjustment contact body 320 of the second direction adjustment part 32 is controlled to come into contact with the mold body 200, the mold body 200 may move in the second direction (for example, the Y-axis direction). According to an embodiment, the adjustment contact body 320 of the second direction adjustment part 32 may come into contact with the mold body adjustment surface 205 to move the mold body 200 in the second direction.

A position of the mold part 20 may be measured by a second direction measurement part 42 which comes into contact with the mold part 20. When a position of the mold body 200 in the second direction with respect to the base part 10 is set by the second direction adjustment part 32, the position, a movement amount, and/or a rotation angle of the mold body 200 may be confirmed using a value measured by the second direction measurement part 42 of the measurement part 40.

The mold part 20 may be precisely moved with respect to the base part 10, and a clearance may be precisely adjusted by the adjustment part 30 and the measurement part 40 through the first direction adjustment operation S100, the first direction adjustment release operation S200, and the second direction adjustment operation S300 described above.

The adjustment part fixing operation S400 (see FIG. 7) of fixing the first direction adjustment part 31 and the second direction adjustment part 32 will be described. Referring to FIG. 10, when the mold body 200 is moved using the value measured by the measurement part 40 in the first direction adjustment operation S100 and the second direction adjustment operation S300, the clearance may be precisely adjusted.

The position of the mold part 20 moved using the value measured by the measurement part 40 may be fixed by the adjustment part 30, and movement of the mold part 20 may be restricted. The mold body contact surface 204 of the mold body 200 may come into contact with the adjustment support body 330 to fix the mold body 200. The mold body adjustment surface 205 of the mold body 200 may come into contact with the adjustment contact body 320 to fix the mold body 200. As described above, the movement in the first direction and/or the second direction may be restricted by the adjustment contact body 320, and rotation in a clockwise direction and/or counterclockwise direction may be restricted by the adjustment support body 330.

Referring to FIGS. 7 and 11 to 13, the first direction adjustment operation S100 (see FIG. 7) of moving the mold part 20 with respect to the base part 10 using the first direction adjustment part 31 will be described.

Referring to FIG. 11, in the first direction adjustment operation S100, the mold part 20 may be rotated with respect to the base part 10. The adjustment support body 330 of one first direction adjustment part 31 (for example, in a −X-axis direction) of the plurality of first direction adjustment parts 31 may be fixed to the adjustment fixing body 310 while in contact with the mold body 200. In addition, a plurality of second direction measurement parts 42 may come into contact with the mold body 200 to measure a position, a movement amount, and/or a rotation angle of the mold body 200.

As one first direction adjustment part 31 of the plurality of first direction adjustment parts 31 comes into contact with the mold body 200 and is fixed to the adjustment fixing body 310 in a state in which the adjustment support body 330 is in contact with the mold body 200, the mold body 200 may substantially rotate about the adjustment fixing body 310. As the mold body 200 rotates, a position, a movement amount, and/or a rotation angle of the mold body 200 may be measured by the second direction measurement parts 42. The rotation angle of the mold body 200 may be calculated through a difference in value measured by the plurality of second direction measurement parts 42.

When the rotation of the mold body 200 ends, a remaining first direction adjustment part 31 that has not come into contact with the mold body 200 may come into contact with the mold body 200. As the remaining first direction adjustment part 31 that has not come into contact with the mold body 200 comes into contact with the mold body 200, movement of the mold body 200 in the second direction may be restricted. The mold body 200, of which the movement in the second direction is restricted, may be moved in the first direction by the adjustment contact body 320 of the first direction adjustment part 31.

Referring to FIG. 12, the adjustment support body 330 of the first direction adjustment part 31 may be fixed to the adjustment fixing body 310 while in contact with mold body 200. According to an embodiment, the adjustment support body 330 may be fixed to the adjustment fixing body 310 while in contact with the mold body contact surface 204. When the adjustment support body 330 of the first direction adjustment part 31 is fixed to the adjustment fixing body 310, movement of the mold body 200 in the second direction (for example, the Y-axis direction) may be restricted. In the state in which the movement of the mold body 200 in the second direction is restricted, if the adjustment contact body 320 of the first direction adjustment part 31 is controlled to come into contact with the mold body 200, the mold body 200 may move in the first direction (for example, the X-axis direction). According to an embodiment, the adjustment contact body 320 of the first direction adjustment part 31 may come into contact with the mold body adjustment surface 205 to move the mold body 200 in the first direction.

In an embodiment, a plurality of first direction measurement parts 41 may measure a position, a movement amount, and/or a rotation angle of the mold body 200 while the mold body 200 moves in the first direction. A state of the mold body 200 may be observed while the position, the movement amount, and/or the rotation angle of the mold body 200 are measured by the plurality of first direction measurement parts 41.

The first direction adjustment release operation S200 (see FIG. 7) of releasing fixation of the first direction adjustment part 31 may be the same as the process described with reference to FIGS. 8 to 10.

Referring to FIG. 13, the adjustment support body 330 of the second direction adjustment part 32 may be fixed to the adjustment fixing body 310 while in contact with the mold body 200. According to an embodiment, the adjustment support body 330 may be fixed to the adjustment fixing body 310 while in contact with the mold body contact surface 204. Accordingly, rotation of the mold body 200 with respect to the base part 10 may be restricted. When the adjustment support body 330 of the second direction adjustment part 32 is fixed to the adjustment fixing body 310, movement of the mold body 200 in the first direction (for example, the X-axis direction) may be restricted. In a state in which the movement of the mold body 200 in the first direction is restricted, if the adjustment contact body 320 of the second direction adjustment part 32 is controlled to come into contact with the mold body 200, the mold body 200 may move in the second direction (for example, the Y-axis direction). According to an embodiment, the adjustment contact body 320 of the second direction adjustment part 32 may come into contact with the mold body adjustment surface 205 to move the mold body 200 in the second direction.

A position of the mold part 20 may be measured by the first direction measurement part 41 and/or the second direction measurement part 42 in contact with the mold part 20. When a position of the mold body 200 in the second direction with respect to the base part 10 is set by the second direction adjustment part 32, the position, a movement amount, and/or a rotation angle of the mold body 200 may be confirmed using a value measured by the second direction measurement part 42 of the measurement part 40.

The mold part 20 may be precisely rotated and moved with respect to the base part 10 and a clearance may be precisely adjusted by the adjustment part 30 and the measurement part 40 through the first direction adjustment operation S100, the first direction adjustment release operation S200, and the second direction adjustment operation S300 described above. In a state in which the clearance is precisely adjusted, a position of the mold body 200 may be fixed to the base part 10 through the adjustment part fixing operation S400 (see FIG. 7) of fixing the first direction adjustment part 31 and the second direction adjustment part 32.

According to embodiments of the present invention, a battery with improved precision can be provided using a battery manufacturing apparatus and a battery manufacturing method.

According to embodiments of the present invention, a defect rate of cans can be minimized or reduced using a battery manufacturing apparatus and a battery manufacturing method.

However, aspects and effects obtainable through the present disclosure are not limited to the above aspects and effects, and other technical aspects and effects that are not mentioned will be clearly understood by those skilled in the art from the following description of the present disclosure.

While the present disclosure has been described with reference to some embodiments shown in the drawings, these embodiments are merely illustrative and it is to be understood that various modifications and equivalent or other embodiments can be derived by those skilled in the art on the basis of the described embodiments.

Therefore, the technical scope of the present disclosure should be defined by the claims.

What is claimed is:

1. A battery manufacturing apparatus comprising:
a base;
a mold comprising a mold body movably arranged on the base, and a shape determination body inserted in the mold body; and
an adjuster which is fixed to the base and configured to come into contact with the mold body to move the mold body.

2. The battery manufacturing apparatus as claimed in claim 1, wherein
a slug is arrangeable in the mold, and
the slug is insertable into a shape determination hole defined in the shape determination body by a punch to be molded into a can.

3. The battery manufacturing apparatus as claimed in claim 1, wherein the adjuster comprises:
a first direction adjuster on each of two sides of the mold body in a first direction; and
a second direction adjuster on each of two sides of the mold body in a second direction perpendicular to the first direction.

4. The battery manufacturing apparatus as claimed in claim 3, wherein each of the first direction adjuster and the second direction adjuster comprises:
an adjustment fixing body fixed to the base; and
an adjustment contact body which comes into contact with the mold body to adjust a distance between the adjustment fixing body and the mold body.

5. The battery manufacturing apparatus as claimed in claim 4, wherein
each of the first direction adjuster and the second direction adjuster comprises an adjustment wedge block having a wedge shape which protrudes from the adjustment fixing body and of which a width decreases away from the mold body, and
each of the first direction adjuster and the second direction adjuster further comprises an adjustment wedge hole which is formed in the adjustment wedge block and in which the adjustment contact body is inserted.

6. The battery manufacturing apparatus as claimed in claim 4, wherein each of the first direction adjuster and the second direction adjuster further comprises an adjustment support body located between the adjustment fixing body and the mold body to come into contact with the adjustment fixing body and the mold body.

7. The battery manufacturing apparatus as claimed in claim 1, further comprising a measurer which is fixed to the base and is in contact with the mold body to measure a movement amount of the mold body.

8. The battery manufacturing apparatus as claimed in claim 7, wherein the measurement part comprises:
a first direction measurer on a side surface of the mold body in the first direction; and
a second direction measurer on a side surface of the mold body in the second direction.

9. The battery manufacturing apparatus as claimed in claim 8, wherein each of the first direction measurer and the second direction measurer comprises:
a measurement body fixed to the base;
a measurement contact portion which protrudes from the measurement body and is in contact with the mold body; and
a measurement gauge configured to display a distance between the measurement body and the measurement contact portion.

10. The battery manufacturing apparatus as claimed in claim 9, wherein the first direction measurer and the second direction measurer are provided as a plurality of first direction measurers and a plurality of second direction measurers, respectively.

11. The battery manufacturing apparatus as claimed in claim 10, wherein the adjuster is located between the plurality of first direction measurers or between the plurality of second direction measurers.

12. The battery manufacturing apparatus as claimed in claim 1, wherein
the mold comprises a mold body recess comprising a groove formed in the mold body to be concave inward, and
the adjuster is inserted in the mold body recess.

13. The battery manufacturing apparatus as claimed in claim 12, wherein the mold body recess comprises:
mold body adjustment surfaces facing each other; and
a mold body contact surface connecting the mold body adjustment surfaces.

14. The battery manufacturing apparatus as claimed in claim 13, wherein the adjuster comprises:
an adjustment fixing body fixed to the base part;
an adjustment wedge block protruding from the adjustment fixing body;
an adjustment contact body which passes through the adjustment wedge block and comes into contact with the mold body adjustment surface; and
an adjustment support body which comes into contact with the adjustment wedge block and the mold body contact surface.

15. A battery manufacturing method comprising:
a first direction adjustment comprising moving a mold with respect to a base using a first direction adjuster;
a first direction adjustment release comprising releasing fixation of the first direction adjuster; and
a second direction adjustment comprising moving the mold with respect to the base using a second direction adjuster.

16. The battery manufacturing method as claimed in claim 15, further comprising an adjuster fixing comprising fixing the first direction adjuster and the second direction adjuster after the second direction adjustment.

17. The battery manufacturing method as claimed in claim 16, wherein, in the first direction adjustment, the mold is rotated with respect to the base.

18. The battery manufacturing method as claimed in claim 16, wherein, in the first direction adjustment, a position of the mold is measured by a first direction measurer in contact with the mold.

19. The battery manufacturing method as claimed in claim 16, wherein, in the second direction adjustment, a position of the mold is measured by a second direction measurer in contact with the mold.
